(19) United States
(12) Patent Application Publication
(10) Pub. No.: US 2003/0132641 A1
(43) Pub. Date: Jul. 17, 2003

(54) Method and tool for holding sheet material

(75) Inventors: John L. Ponec, Eagle, NE (US); Jimmy D. Hohensee, Lincoln, NE (US)

Correspondence Address: VINCENT L. CARNEY LAW OFFICE, P.O. BOX 80836, LINCOLN, NE, 68501-0836, US

(73) Assignee: HOPO L.L.C., Eagle, NE (US)

(21) Appl. No.: 10/047,286

(22) Filed: Jan. 14, 2002

(51) Int. Cl. B65G 7/12

(52) U.S. Cl. 294/15

(57) ABSTRACT

In using the tool, two tools are mounted by their first grips on an upper edge of a sheet of drywall spaced from each other. A tool for carrying drywall material includes a web section having first and second ends with a corresponding one of a first gripping means and a second gripping means on its opposite ends extending outward from opposite planes of the web, the length of the web being 24 inches. A sheet to be positioned for fastening or carrying is supported on the second grip of the two tools. The sheet of drywall can be worked on in this position or can be gripped near its center, lifted safely and carried from place to place.

### BACKGROUND OF THE INVENTION

This invention relates to methods and tools for holding sheet material, such as for example, methods and tools for handling drywall material.

It is frequently necessary to move sheet material from place to place and to position it for use, such as for example, in the use of dry wall material, plywood, gypsum plasterboard, wall board or the like in construction projects. In the prior art, such work was generally done by hand.

Moving the sheets by hand has the disadvantages of creating unnecessary fatigue, causing back strain and reducing safety. These disadvantages occur for several reasons, such as for example: (1) some construction sheet material such as a sheet of drywall may be clumsy and difficult to carry, to lift into place or to support because of its size, shape and weight; (2) under some circumstances obtaining a grip for lifting the sheet requires bending to the ground; (3) the workman may need to bend or sit or kneel on the floor or ground while working on the material; (4) it is frequently clumsy to carry the material because the sheet is carried too high in elevation, making it difficult to see and requiring stooping to gain access to certain locations; (5) it is difficult to carry the sheet when using a drywaller's bench, or when climbing ladders or when on scaffolds or when using a lift to reach an elevated location; and (6) it is difficult to obtain a grip at the center of a large sheet because it must be lifted from one side to get a hand under it but the lifter cannot reach the center of the sheet while holding its side because of the distance from the side to the center.

### SUMMARY OF THE INVENTION

Accordingly, it is an object of the invention to provide a novel technique for handling sheet material.

It is a further object of the invention to provide a novel method for reducing fatique in handling sheet material.

It is a still further object of the invention to provide a novel tool and method for reducing fatigue, reducing backstrain and increasing safety when carrying sheet material.

It is a still further object of the invention to provide a novel tool and novel method for using the tool to move sheets of drywall material (sometimes called rock) from place to place manually or on a lift or the like.

It is a still further object of the invention to provide a novel method and novel tool used in the method for lifting sheet material or supporting it at a desirable height to work on it.

It is a still further object of the invention to provide a novel tool for carrying sheet material.

In accordance with the above and further objects of the invention, a tool is provided having first and second grips or cradles separated and held together by a central web. The central web is strong in tension, and in the preferred embodiment, it is a simple steel plate integrally formed with the grips on each end although any material can be used that is sufficiently strong to hold relatively large sheet material such as the sheets of drywall commonly used in construction. Each of the grips is similar in construction but extends from a different end of the web outwardly from an opposite surface of the web so that one extends in one direction from one edge of the web and the other in the opposite direction from the opposite edge of the web.

Each grip has a resting or supporting plate and a lip so that it may be supported on the top edge of a sheet of material or held by the workman's hand or supported on the front end of a scaffold or any upwardly extending edge with the grip on the other end facing in the opposite direction from the web and able to receive on its supporting plate the bottom edge of a sheet of material to hold it. With this configuration, the upper grip may be carried by a person with the lower grip having one or more sheets of material on it or the upper grip may rest on another edge. It is particularly advantageous for the sheet or sheets to be supportable on the lower grip when the sheets are of different sizes, particularly if they are of different lengths, and the workman needs to carry them. Moreover, the upper grips may hang on a sheet of material and one or more other sheets lifted onto the lower grips for support. Two such tools spaced apart may support a regularly shaped sheet or irregularly shaped sheet (called rippers) of material that can be worked on such as by cutting it or smoothing the surface or the like at a convenient height for the workman. Further, the tool may be used to hold material at a convenient height for gripping it and lifting it into position.

It can be understood from the above description that the tool may be used to practice several different novel methods. The method and tool have several advantages, such as for example: (1) they reduce fatigue and backstrain; (2) they increase safety; (3) they reduce the amount of bending necessary to pick up and position sheet materials; (4) they provide a convenient gripping means for holding material and carrying it from place to place; (5) they provide a support that may rest on any upward edge and be used to support material while it is being lifted or while it is being worked upon at a convenient height; (6) they may be used to hold material that is at an angle; (7) the tool is simple and economical; (8) the tool and methods reduce the amount of time that a drywaller must be bent over or sitting on the floor or ground or kneeling on the floor or ground to work at low levels; (9) they provide an easy method of elevating a sheet of drywall so it may be worked upon at a convenient height; (10) they make carrying sheet material from place to place easier; and (11) they save considerable time and increase productivity.

### SUMMARY OF THE DRAWINGS

The above and further features of the invention will be better understood from the following detailed description when considered in connection with the accompanying drawings in which:

FIG. 1 is a perspective view of a tool for holding sheet material in accordance with an embodiment of the invention;

FIG. 2 is a side elevational view of the tool of FIG. 1;

FIG. 3 is a fragmentary, simplified perspective view of the tool of FIG. 1 supported from sheet material at one end;

FIG. 4 is a side elevational view showing the tool of FIG. 1 resting on sheet material and supporting another section of sheet material at a reasonable elevation;

FIG. 5 is-a side elevational view showing a sheet of material with the tool of FIG. 1 positioned for convenient carrying from place to place;

FIG. 6 illustrates the use of the tool of FIG. 1 to lift and carry one or more sheets of material;

FIG. 7 shows a simplified front elevational view illustrating the use of two fragments or butts of sheet material utilized to hold sheet material at a convenient height by two tools in accordance with the invention for the purpose of being worked upon by a workman;

FIG. 8 is a side elevational view showing the manner in which the tool of FIG. 1 may be moved outwardly from a supporting surface for purposes of being worked upon; and

FIG. 9 shows the manner in which the tool of FIG. 1 may be used to support one side of an irregularly cut piece of sheet material.

### DETAILED DESCRIPTION

In FIG. 1, there is shown an elevational view of a tool 10 for holding sheet material having a spacing web 12 and first and second end grips 14A and 14B respectively. In the embodiment of FIG. 1, the first and second end grips 14A and 14B are substantially identical in shape but mounted to extend at an angle from opposite sides of the web 12 at the opposite edges of the web 12. The web 12 is preferably an elongated member connecting the grips 14A and 14B but may be any convenient length for supporting material at a desirable height. For example when the first grip 14A is held in the hand of an individual and sheet material supported in the second grip 14B, the web 12 should be: (1) sufficiently long to hold the sheet material at a low enough level for easy handling and passage through doors and for convenient visibility by the workman carrying the sheet material; and (2) sufficiently short so that it does not hit the ground when the arm is extended for ease in carrying the sheet material. In the preferred embodiment, the web length is 24 inches but can be shorter or longer in accordance with the purposes of the tool. It should be between 10 inches and 40 inches long. When used for drywall material, the length is not only chosen for ease in carrying but to support a sheet of material from the edge of another sheet or the edge of another convenient object while the sheet of material is being worked on without the workman needing to bend far or kneel or sit on the floor or ground or so that the sheet material can be managed safely.

The web 12 in the preferred embodiment is a solid flat member having a width of six inches and being of 16 gauge steel for ease in forming the first and second grip members 14A and 14B from a single sheet of stock steel. However, it need not be solid, need not be six inches wide nor be of steel since its strength and tension need only be sufficient to support the material being carried. It also does not have to be rigid but can be flexible and lighter. Each of the first and second end members include a supporting plate 16A and 16B respectively and a lip 18A and 18B.

The tool 10 is frequently used in pairs to provide two supports hanging from the top edge of one or more sheets of rectangular material such as a pair of sheets of drywall with the lower grip of the pair of tools being spaced to support another sheet of drywall having its bottom edge resting on the support plate of the two lower grips of the pair of tools. This arrangement holds the sheet of drywall resting on the lower grips of the two tools at a convenient height for a workman to work on it or to obtain a grip on it for carrying from place to place in a safer manageable fashion.

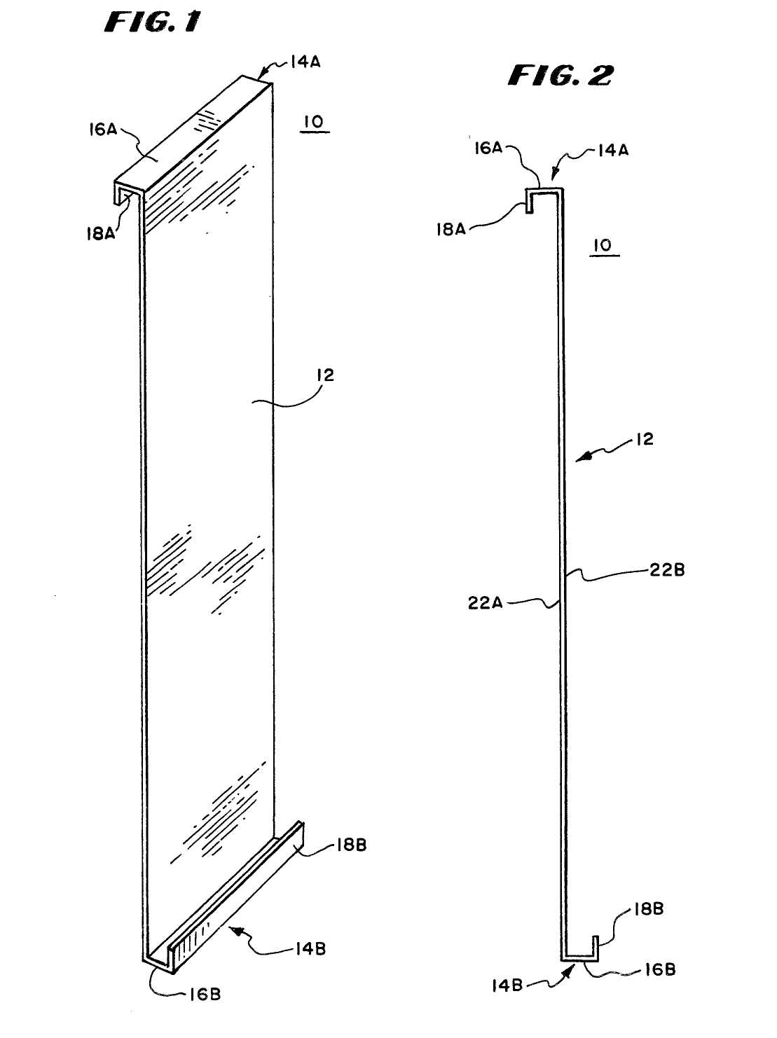

In FIG. 2, there is shown a side elevational view of the tool 10 showing the web 12 with a first surface 22A and a second surface 22B and the grip 14A extending outwardly at one end of the web 12 from the first surface 22A of the web 12 and the grip or cradle 14B extending from the second surface 22B of the web 12 at the other end of the web 12 in the opposite direction, each with its corresponding one of the lips 18A and 18B extending toward the center of the web and its corresponding one of the supporting plates 16A and 16B spacing the corresponding one of the lips 18A and 18B from the web 12. The supporting plates 16A and 16B each have a flat resting surface facing the bottom edge of the web 12 on which sheets can rest or which can rest on the top edge of sheets

In the preferred embodiment, the supporting plates 14A and 14B extend perpendicularly from the surfaces 22A and 22B respectively and the lips 18A and 18B extend perpendicularly from the surfaces of the corresponding ones of the supporting plates 16A and 16B to be parallel and overlie the corresponding web surfaces 22A and 22B. The size of the supporting plates 16A and 16B between the surfaces of the web 12 and the lips 18A and 18B is selected for the thickness of one or more of the sheets that is to be carried. In the preferred embodiment, the size of each supporting plate is one and one-eighth inch by six inches so as to extend one and one-eighth inches from the corresponding surface of the web 12. In the preferred embodiment, the size of the supporting plates 16A and 16B is selected so that a tool may be supported on two sheets of drywall instead of one to provide a stronger support for the tool 10 or two sheets of drywall can rest upon the surface of the supporting plates 16A and 16B.

While the supporting plates 16A and 16B extend orthogonally from the surfaces of the web 12 in the preferred embodiment, they can extend at other angles chosen for convenience from a range of five degrees from the plane of the web to 170 degrees, such as convenience in tilting the tool 10 away from a surface or for holding sheet material having angled edges or the like. Similarly, the lips 18A and 18B in the preferred embodiment are perpendicular to the corresponding supporting plates 16A and 16B but can extend at other angles if desired since they are only selected in height and angle to be able to conveniently receive and hold the sheet material for which the tool is intended. In the preferred embodiment, the lips are three-quarters of an inch by six inches to extend three-quarters of an inch from the edge of the corresponding ones of the supporting plates 16A and 16B.

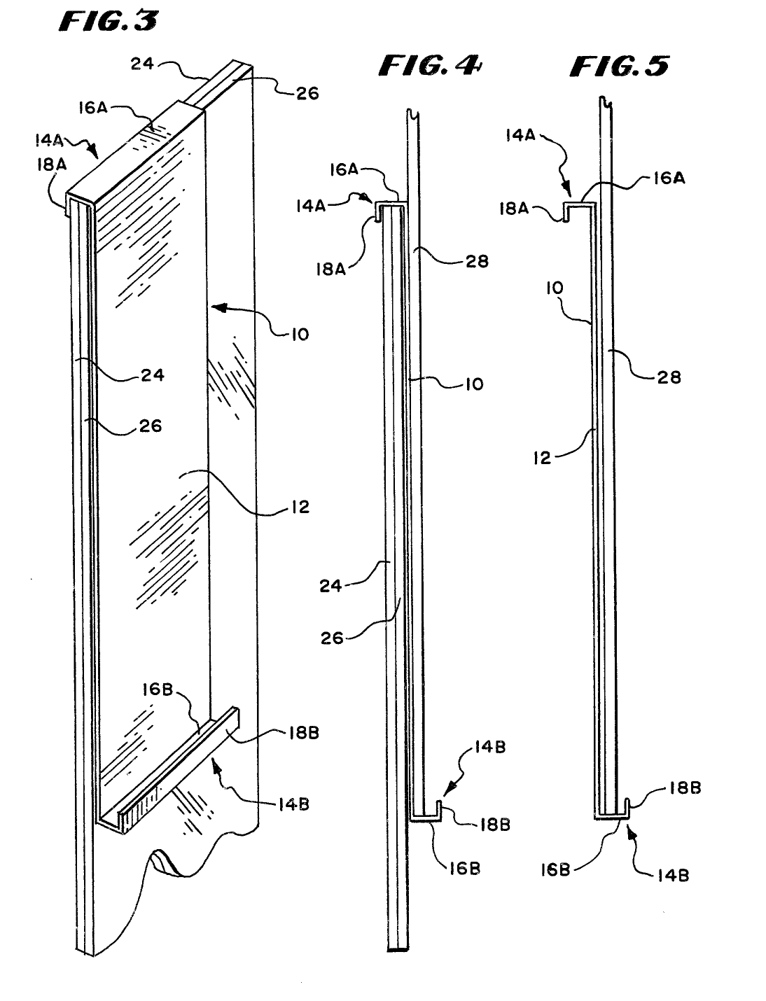

In FIG. 3, there is shown a simplified perspective drawing of the tool 10 supported by two sheets of drywall material 24 and 26. It could be supported by a single sheet if desirable but two sheets provide greater safety and strength and the preferred embodiment of tool is designed for two sheets of drywall material although the tool may have other applications to other kinds of sheet material. As shown in this view, the supporting plate 16A rests on top of the drywall material with the lip 18A extending over the back surface of the drywall material and the web 12 being on the opposite side of the surface. At its bottom edge, the supporting plate 16B extends to offer a flat surface with the lip 18B extending upwardly.

In FIG. 4, there is shown an elevational view of the tool 10 supported on the upper edge of the drywall sheets 24 and 26 and showing how an additional sheet 28 can be supported on the supporting plate 16B and held by the lip 18B. With this arrangement, the sheet 28 is at a convenient height for being worked on such as by being measured or cut or having its surface improved. Moreover, it can be conveniently lifted from the bottom surface by the drywaller for lifting upwardly to its proper location for nailing in place.

In FIG. 5, there is shown an elevational view of the tool 10 having resting upon it the drywall sheet 28. This illustrates a manner in which a drywaller may hold the upper grip 14A while the sheet of drywall rests in the lower grip or cradle 14B. An average drywaller can conveniently carry one or more sheets of drywall material by holding on to the grip 14A and moving it from place to place.

In FIG. 6, there is shown an elevational view of a drywaller 38 carrying two sheets of drywall 30 and 31 of different lengths utilizing the tool 10. As shown in this view, the tool 10 has its bottom cradle or grip 14B holding the lower edge of the shorter sheet of drywall 30 and the longer sheet of drywall 31 while the drywaller holds the upper grip or cradle 14A in one hand and supports the sheets of drywall 30 and 31 with the other hand. In this manner, the two sheets are easily held and carried from place to place. Because the lower grip of the carrier is low, the drywaller can easily see over the top of the sheet of drywall with clear vision.

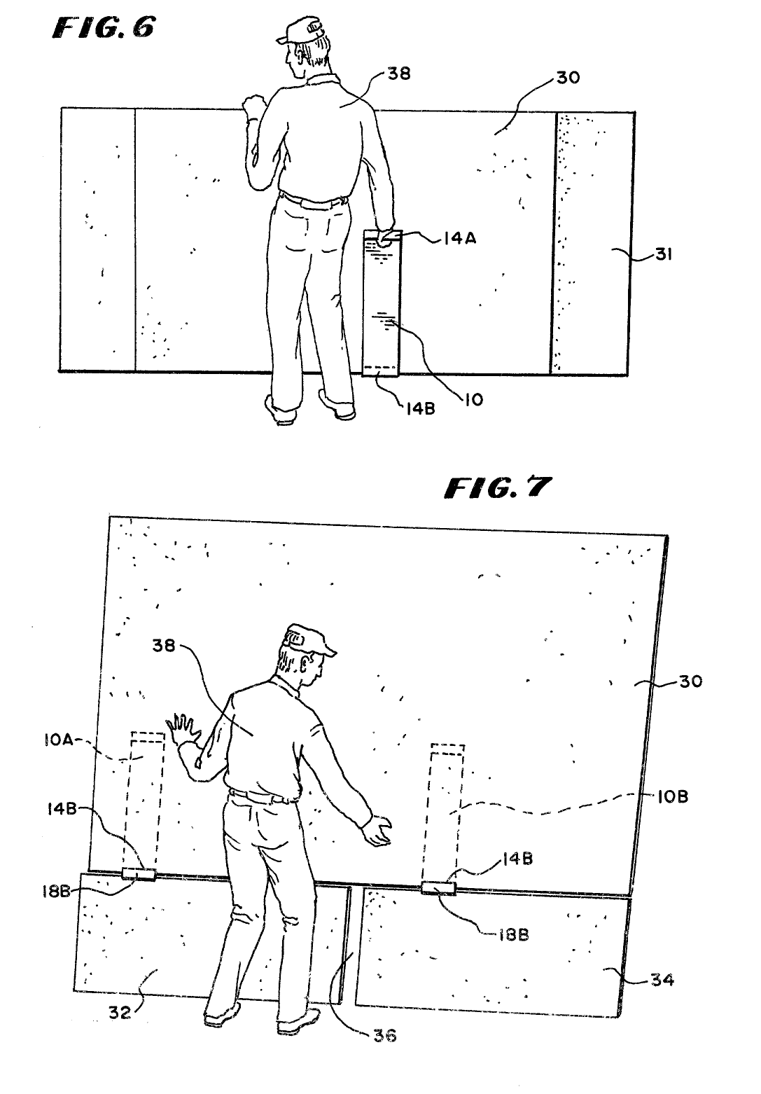

In FIG. 7, there is shown an elevational view of the drywaller 38 working with a sheet of drywall 30 that is resting on two separate sections or butts 32 and 34 of drywall spaced apart as shown by the space 36 between them. A butt is a piece of a full sheet of drywall with no horizontal cuts. Tools 10A and 10B are supported by respective ones of the butts of drywall and the full sheet of drywall 30 that is being worked upon by the drywaller 38 is resting on their bottom grips 14B. In FIG. 7, the tools 10A and 10B are hidden by the sheet of drywall 30. Of course the two tools 10A and 10B could rest on a single sheet of drywall if one is available. In common practice, a stack of drywall sheets is leaned against the wall and the tools 10A and 10B are hung on two sheets near opposite ends of the sheets behind the sheet that is to be lifted. The top sheet or outer sheet is then lifted one end and then the other onto the grips 14B of each of the two tools 10A and 10B so that the drywaller 38 can easily lift it into place or can work on it while it is resting at a convenient height. The drywaller has better control over the sheet of drywall upon which he is working when it is held by the two tools than if the drywaller was holding it in his hands or if the drywaller had to work on it while it rested on a floor or the ground. The workman would work on a rip instead of the full sheet 30.

In FIG. 8, there is shown a side elevational view of two sheets of drywall 24 and 26 and the tool 10. The grip 14A rests on the upper edges of the two sheets of drywall 24 and 26. The lower grip 14B has received the lower edge of a sheet of drywall 28. This view illustrates the ease by which the bottom of the tool 10 can be pulled outwardly so that the sheet of drywall 28 swings away from the sheet of drywall 26 and can be conveniently worked upon such as by cutting it or the like.

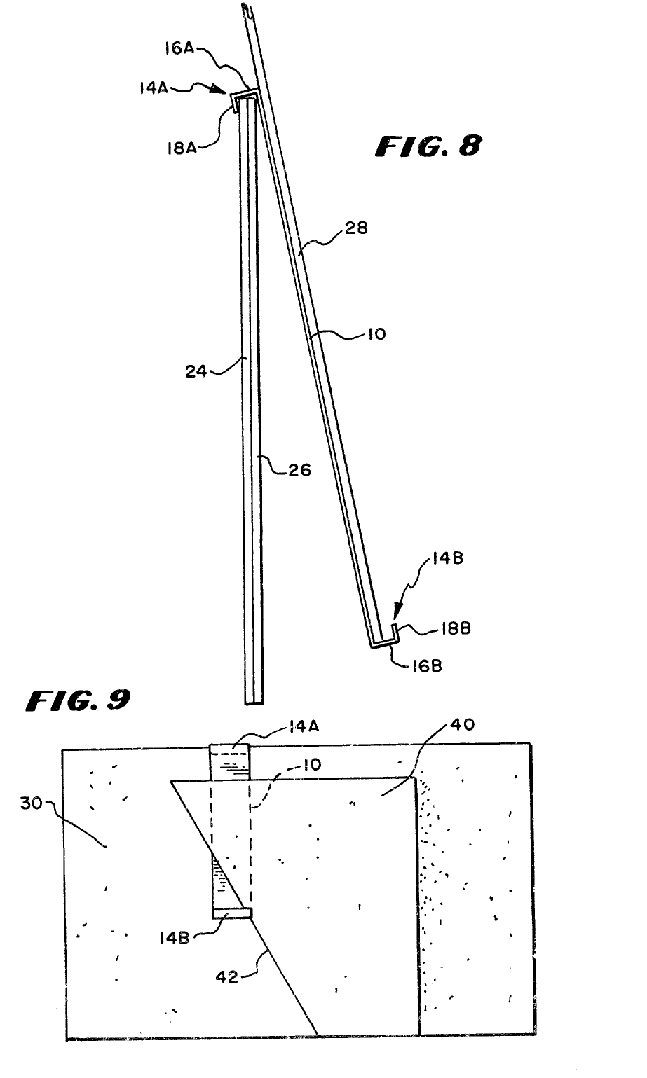

In FIG. 9, there is shown the tool 10 having its upper edge rested on the upper edge of a sheet of drywall 30 and its lower grip engaged in a angle cut of another sheet of drywall 40. As illustrated in this embodiment, an irregular edge 42 is supported by a portion of the bottom grip 14B of tool 10 so that the irregularly cut sheet of drywall 40 does not fall onto its edge 42. Thus, the tool 10 can aid in working upon an angular cut such as might have been salvaged from a stairwell. Thus, the use of the tool permits easier cutting of an irregularly-shaped sheet of drywall by giving it stability to form a useable shape for the drywall.

The tool 10 has several modes of use. For example it may be used to hold a sheet of drywall at a more convenient height. To do so, a pair of tools 10A and 10B are mounted to a single full sheet of drywall, two full sheets of drywall one in front of the other to-form a double thickness for strength, two spaced-apart butts of drywall or two spaced apart pairs of butts of drywall with one butt of each pair being in front of the other butt of the pair. In these arrangements, the top grip 14A is mounted to the top edge of the sheet or sheets of drywall or butts of drywall with the bottom grip 14B on front of the full sheets or butts of drywall. The butts of drywall or pairs of butts of drywall are spaced apart, a distance shorter than the length of the sheet of drywall to be lifted. One side of the sheet of drywall can be lifted by hand onto the lower grip 14B of one of the tools and then the other side lifted onto the lower grip of the second tool.

To avoid bending, the tool may be slid under a sheet of material that is resting on the ground and used to lift the sheet. The tool can be used to lift the sheet one side at a time or slid to the center of the sheet to be lifted and the entire sheet lifted. After the side or whole sheet is lifted, its bottom edge is rested on the supporting plate 16B of the bottom grip 14B of the first tool if one side is lifted or the bottom grip 16B of both tools if the entire sheet is lifted. If one side is lifted onto one tool, then the other end is lifted and rested on the supporting plate 16B of the bottom grip 14B of the second tool. The sheet can then be worked upon or gripped by its bottom edge near the center of the sheet for balance and carried.

It can be understood from the above description that the tool 10 may be used to practice several different novel methods. The method and tool have several advantages, such as for example: (1) they reduce fatigue and backstrain; (2) they increase safety; (3) they reduce the amount of bending necessary to pick up and position sheet materials; (4) they provide a convenient gripping means for holding material and carrying it from place to place; (5) they provide a support that may rest on any upward edge and be used to support material while it is being lifted or while it is being worked upon at a convenient height; (6) they may be used to hold material that is at an angle; (7) the tool is simple and economical; (8) the tool and methods reduce the amount of time that a drywaller must be bent over or sitting on the floor or ground, or kneeling on the floor or ground to work at low levels; (9) they provide an easy method of elevating a sheet of drywall so it may be worked upon at a convenient height; (10) they make carrying sheet material from place to place easier; and (11) they save considerable time and increase productivity.

Although a preferred embodiment of the invention has been described in some detail, many modifications and variations in the preferred embodiment are possible within the light of above teachings. Therefore, it is to be understood that, within the scope of the appended claims, the invention may be practiced other than as specifically described.

What is claimed is:

1. A tool for carrying sheet material comprising:
a web section having first and second ends with a predetermined length between said first and second ends;
a first gripping means on the first end of said web section;
a second gripping means on a second end of said web section;
said predetermined length between the first and second ends of said web section being between 10 inches and 40 inches, whereby the sheet material resting on the second end and held on its first end will not scrape against the ground when carried;
said first and second ends having a surface extending at an angle to the web section whereby sheet material may rest upon it; and
one of said first and second gripping means extending from a first surface of said web section and the other extending from a second surface of said web section.

2. The tool of claim 1 in which the web section is 24 inches in length.

3. The tool of claim 1 in which each of said gripping means includes a resting plate extending at an angle from a different one of the surfaces of said web section and a lip member extending at an angle to said resting plate.

4. A method of moving sheet material comprising the steps of:
placing a flat resting surface under a bottom edge of the sheet material;
lifting the bottom resting surface with the sheet material on it upwardly by the other end of an elongated connecting member; and
carrying the sheet material to a different place.

5. The method of claim 4 in which the step of lifting the bottom resting surface with the sheet material on it comprises the step of lifting the sheet material by gripping an upper end grip on a first end of said elongated connecting member with a hand while the bottom edge of said sheet material rests upon the resting surface at said other end.

6. The method of claim 4 in which the step of lifting said bottom resting surface includes the step of mounting an upper end grip on the other end of the elongated connecting member to an edge on a lift and moving the lift upwardly.

7. A method of supporting sheet material comprising the steps of:
mounting an upper resting plate on a top edge of a sheet of material; and
lifting a second sheet of sheet material upwardly and placing its bottom edge on a lower resting plate spaced from said top resting plate and connected thereto by a web member.

8. A method of claim 7 further including the step of resting a third resting plate upon an upper edge of sheet material and lifting said second sheet of material upwardly so as to rest upon a fourth resting plate spaced from and connected to said third resting plate, whereby said second sheet material is supported by two different spaced apart supporting plates at its bottom edge.
